(19) United States
(12) Patent Application Publication
(10) Pub. No.: US 2019/0357586 A1
(43) Pub. Date: Nov. 28, 2019

(54) Mold Extender

(71) Applicant: Michael Joy, Oak Park, IL (US)

(72) Inventor: Michael Joy, Oak Park, IL (US)

(21) Appl. No.: 15/989,813

(22) Filed: May 25, 2018

(51) Int. Cl. A23P 30/00; A47J 43/20

(52) U.S. Cl. CPC A23P 30/00; A47J 43/20

(57) ABSTRACT

A device to increase the output of a two-part mold is disclosed. The device includes a first side and a second side where each side includes one or more cavities. The cavities receive the material that is to be casted. The device further includes registration keys and registration keyholes such that it can couple with the two parts of a two-part mold.

### BACKGROUND OF THE INVENTION

The present disclosure relates generally to molds. More specifically, the present disclosure relates to an extender for use with two-part molds.

Molds are commonly used to form a liquid or pliable material, such as food, plastic, wax, glass, resin, metal, or ceramic to into a specific shape and/or design. Molds generally include a cavity portion where the user injects the filling they wish to shape. As the filling hardens, it adopts the shape of the cavity. For example, a cook may fill a cooking mold with melted chocolate in order to shape the chocolate into specific shapes and designs. The final hardened product may be referred to as a casting.

Molds are generally one-part or two-part. One-part molds, such as an ice cube tray, are generally open-faced. Two-part molds may include two separate pieces that are coupled together to create the casting. One method of use for a two-part mold is to couple the two separate pieces and then inject the filling through a small opening near the top of the mold.

The output from two-part molds is limited by the number of available cavities. For example, a two-part mold of eight cavities can only produce eight castings. If a user wished to produce additional casting, he must purchase additional molds, which leads to added expenses. Furthermore, the use of multiple molds takes up additional space, which can be of vital importance in various industries such as the food-preparation industry where kitchen space is at a premium, such as in small restaurants and cruise ships.

Accordingly, there is a need for a mold that can be inserted in between a two-part mold so as to create additional castings, as described herein.

### BRIEF SUMMARY OF THE INVENTION

To meet the needs described above and others, the present disclosure provides a mold extender.

The mold extender may include a first side and a second side wherein each side includes one or more cavities. In practice, the mold extender that is used with a specific two-part mold may have the same length and height as the two-part mold. One side of the mold extender may include one or more registration keys while the other side may include one or more registration keyholes. The registration keys of the mold extender may be able to lock into the registration keyholes of the corresponding two-part mold while the registration keyholes of the mold extender may be able to lock into the registration key of the corresponding two-part mold. The mold extender may double the output of a two-part mold.

The mold extender may also include internal vents that may assist in cooling the mold filling. The vents may also prevent the build-up of air in each cavity, therefore lowering the likelihood that the mold will produce casting that have defects and/or are not fully formed.

The mold extender may be used with molds from a variety of industries, including, but not limited to, the food preparation, medical, pharmaceutical, veterinary, and cosmetic industries.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The figures depict one or more implementations in accord with the present concepts, by way of example only, not by way of limitations. In the figures, like reference numerals refer to the same or similar elements.

FIG. 1 is a perspective view of a coupled two-part mold without an extender.

FIG. 2 is a front facing view of an uncoupled two-part mold without an extender.

FIG. 3 is one embodiment of a registration key and registration keyhole.

FIG. 4 is one embodiment of a registration key and registration keyhole.

FIG. 5 is a perspective view of a partially coupled two-part mold without an extender.

FIGS. 6a and 6b are perspective views of a mold extender.

FIGS. 7a and 7b are front facing views of the two sides of the mold extender described in FIGS. 6a and 6b.

FIG. 8 is a perspective view of a partially coupled two-part mold with an extender.

FIG. 9 is a perspective view of multiple mold extenders coupled together.

### DETAILED DESCRIPTION OF THE INVENTION

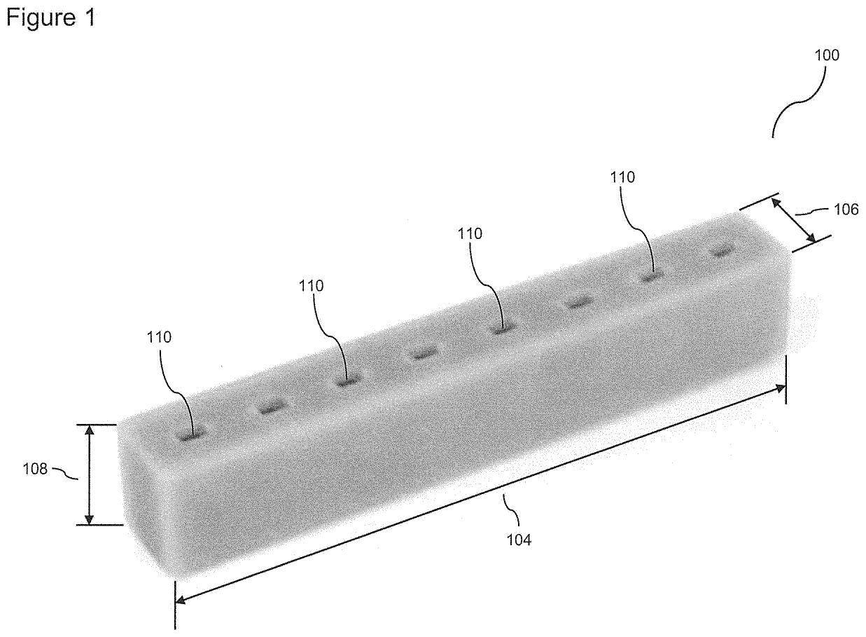

FIG. 1 illustrates an example of a two-part mold 100 in its coupled state. The two-part mold 100 includes a length 104, a width 106, and a height 108. The holes 110 may allow excess filling to escape the two-part mold and also assist in hardening the casting.

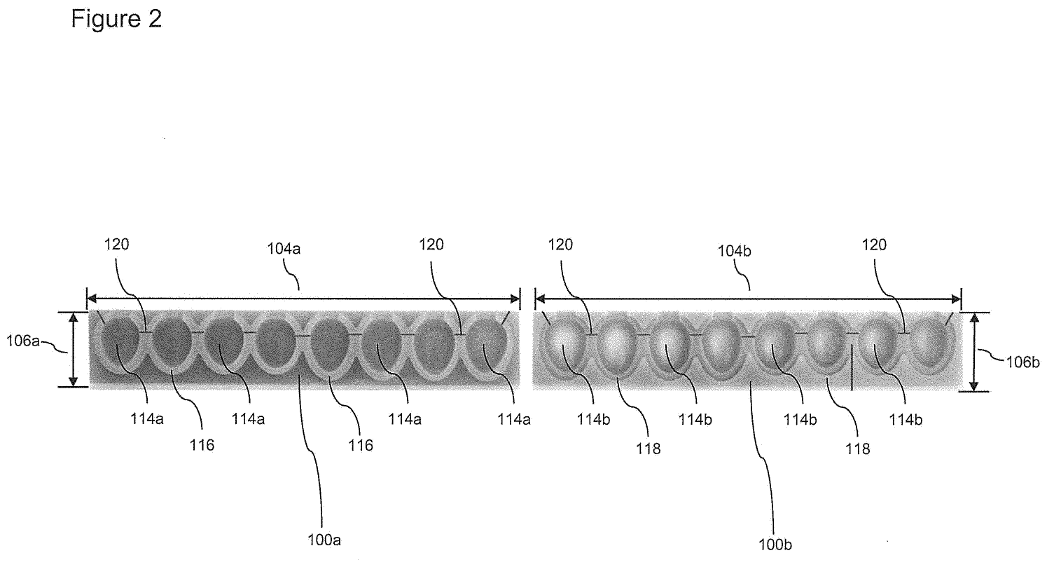

FIG. 2 illustrates the two-part mold 100 of FIG. 1 in its uncoupled state. As shown in FIG. 2, two-part mold 100 in its uncoupled state includes a first mold portion 100a and second mold portion 100b. The first mold portion 100a includes one or more cavities 114a and the second mold portion 100b includes one or more cavities 114b. The number of cavities 114a in the first mold portion 100a may be identical to the number of cavities 114b in the second mold portion 100b. The cavities 114a may be identical in shape, size, and volume to the cavities 114b.

Additionally, the first mold portion 100a may include one or more registration keys 116 and the second mold portion 100b may include one or more registration keyholes 118. The registration keys 116 may form the outside border of the cavities 114a. The registration keyholes 118 may form the outside border of the cavities 114b.

When the first mold portion 100a and second mold portion 100b are coupled, the registration keys 116 may register with the registration keyholes 118 so as to create a seal between the first mold portion 100a and second mold portion 100b (as seen in FIG. 1). When the first portion 102a and second portion 102b are coupled as in FIG. 1, the cavities 102a and cavities 102b are aligned so as to create three-dimensional casting.

Furthermore, as seen in FIG. 2, the first mold portion 100a and second mold portion 100b may also include one or more vents 120. The one or more vents 120 may assist in hardening the filling in the cavities 114a and 114b and may also prevent air pockets from forming within filling.

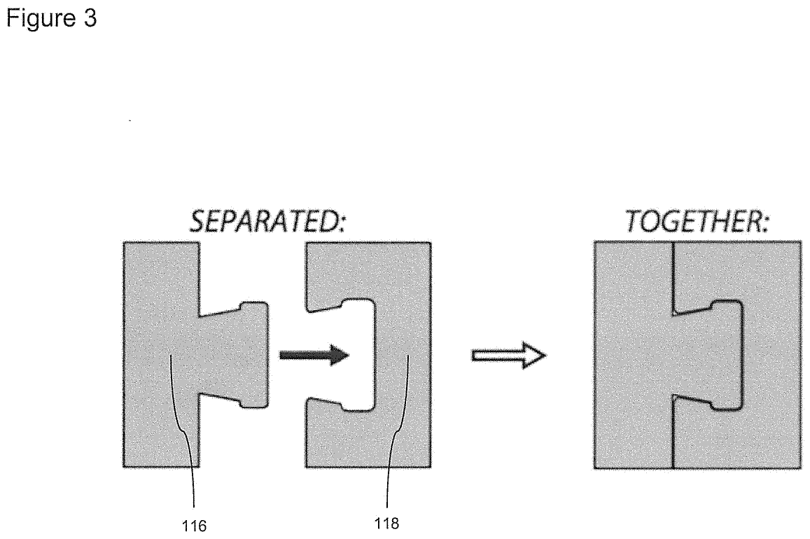

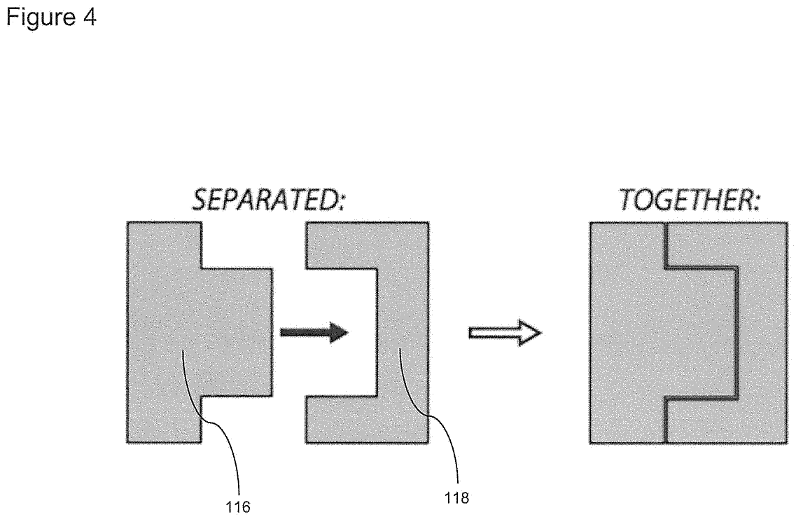

FIGS. 3 and 4 illustrate two possible configurations for the registration key 116 and registration keyhole 118. As seen in FIGS. 3 and 4, the registration key 116 fits into registration keyhole 118 so as to create a seal between the first mold portion 100a and second mold portion 100b.

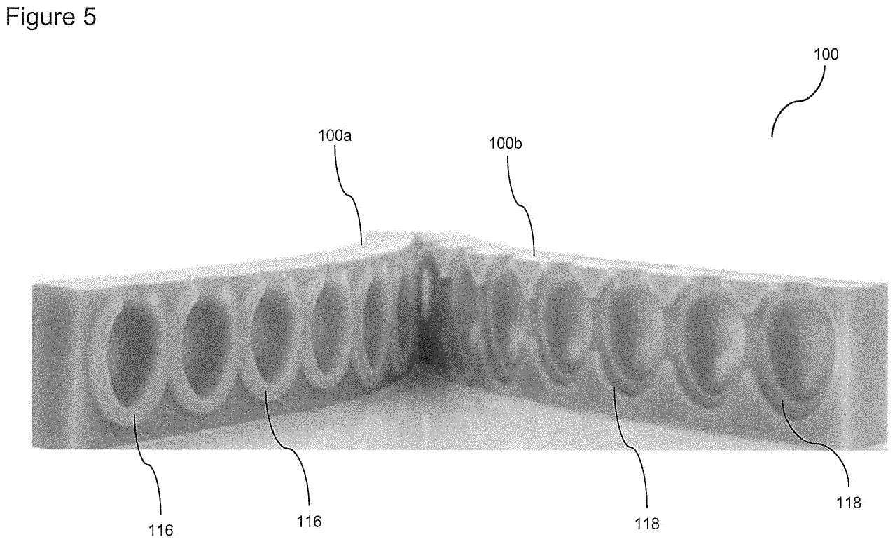

FIG. 5 illustrates the process of coupling the first mold portion 100a with the second mold portion 100b so as to form the two-part mold 100 in its coupled state as seen in FIG. 1. As seen in FIG. 5, when the first mold portion 100a and second mold portion 100b are coupled, the registration keys 116 fit into the corresponding registration keyholes 118 so as to create a substantially sealed two-part mold 100.

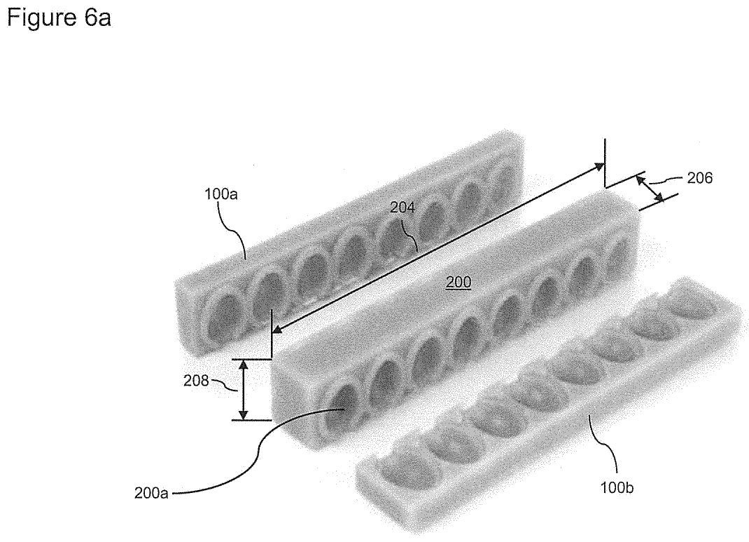

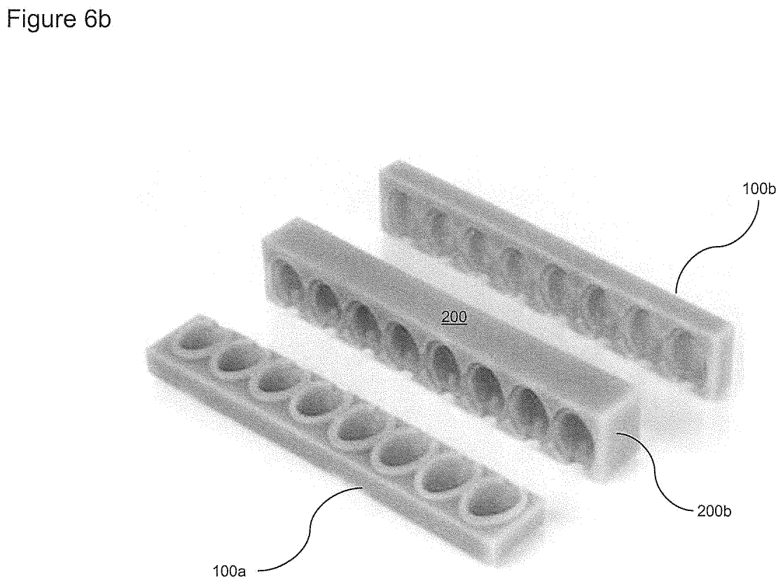

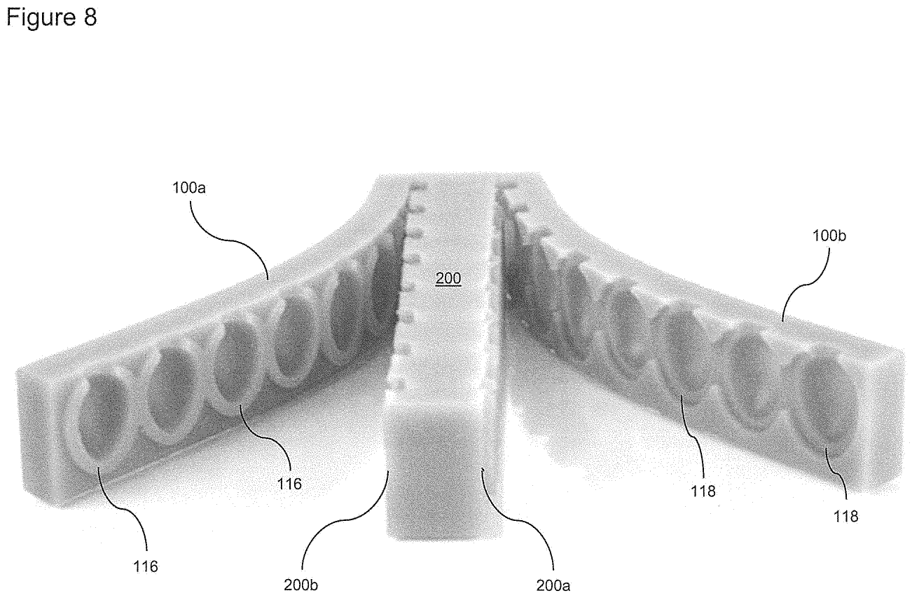

FIGS. 6a and 6b illustrates an example embodiment of the mold extender 200 that is intended to use with the two-part mold 100 seen in FIGS. 1, 2, and 5. The mold extender 200 includes a length 204, a width 206, and a height 208. The length 204 is identical or nearly identical with the two-part mold length 104. The width 206 is identical or nearly identical with the two-part mold width 106. The height 208 is identical or nearly identical with the two-part mold height 108. As seen in FIGS. 6a and 6b, the mold extender 200 may also include a first side 200a and a second side 200b. As further described in FIG. 8, the first side 200a may be coupled with the second mold portion 100b and the second side 200b may be coupled with the first mold portion 100a.

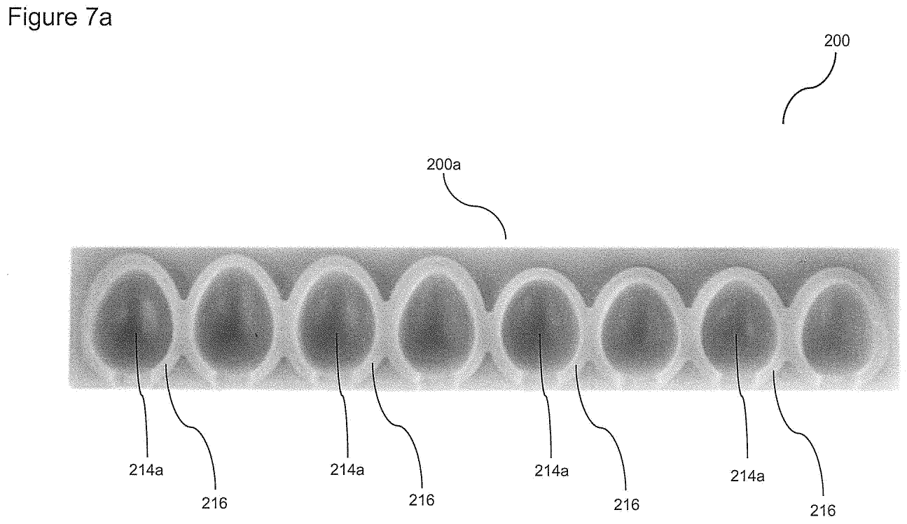

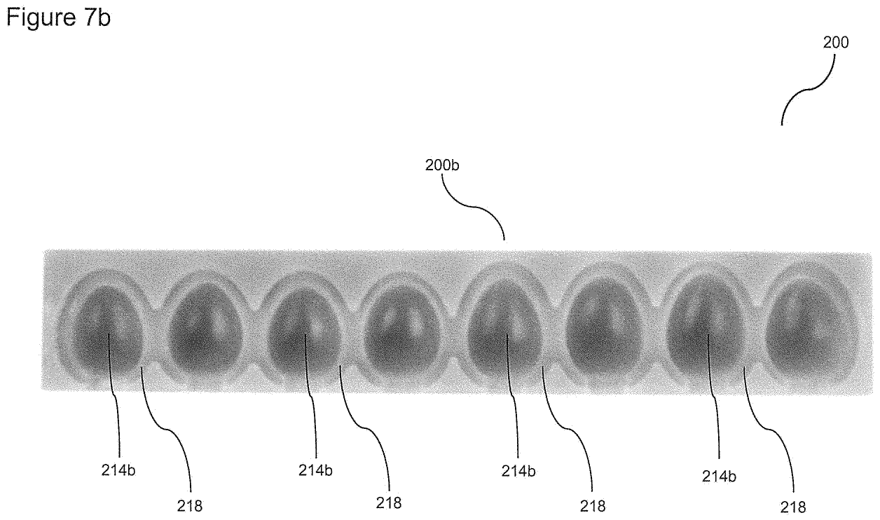

FIG. 7a illustrates a front facing view of the first side 200a of the mold extender 200. As seen in FIG. 7a, the front side 200a of the mold extender 200 includes one or more cavities 214a. The front side 200a also includes one or more registration keys 216. The registration keys 216 may register with the registration keyholes 118 so as to create a seal between the front side 200a of the mold extender 200 and second mold portion 100b.

FIG. 7b illustrates a front facing view of the back side 200a of the mold extender 200. As seen in FIG. 7b, the back side 200a of the mold extender 200 includes one or more cavities 214b. The back side 200b also includes one or more registration keys 216. The registration keys 216 may register with the registration keyholes 118 so as to create a seal between the back side 200a of the mold extender 200 and the first mold portion 100a. Although not shown in FIGS. 7a and 7b, the mold extender may include vents similar to vents 120 of the two-part mold 100.

FIG. 8 illustrates the process of coupling the mold extender 200 with the first mold portion 100a and second mold portion 100b. When the mold extender 200 is coupled with the first mold portion 100a and second mold portion 100b, the registration keys 216 fit into the corresponding registration keyholes 118 and the registration keys 116 fit into the corresponding registration keyholes 218 to create a seal between the extender 200 and first mold portion 100a and second mold portion 100b. A person of ordinary skill in the art will recognize that the registration keys 116 and registration keyholes 118 described in FIGS. 3 and 4 can be utilized by registration keys 216 and registration keyholes 218 of the mold extender 200.

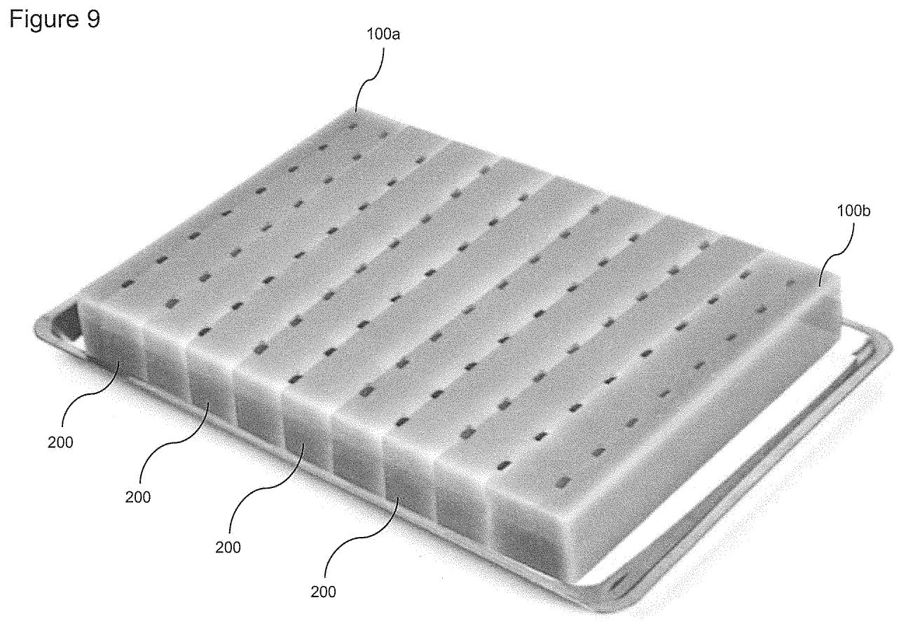

FIG. 9 illustrates an example of multiple extenders 200 coupled between the first mold portion 100a and the second mold portion 100b. The registration keys 216 of the mold extender 200 can couple with the registration keyholes of another mold extender 200, which may in turn couple with another mold extender 200. In the instance where multiple mold extenders 200 are coupled together, the first mold extender 200 in the sequence may be coupled with the first mold portion 100a while the last mold extender 200 in the sequence may be coupled with the second mold portion 100b.

While various embodiments of the invention have been described, it will be apparent to those of ordinary skill in the art that many more embodiments and implementations are possible within the scope of the invention. The mold extender can be filled with a variety of materials, including, but not limited to, food, plaster, wax, resin, epoxies, synthetic materials, gels, elastomers, cement, soaps, lotions, and other mediums related to the cosmetic, medical, pharmaceutical, industrial, and/or veterinary industries. Accordingly, the invention is not to be restricted except in light of the attached claims and their equivalents.

1. A device to increase the output of a two-part mold, comprising:
a mold extender, comprising:
a first side and a second side; and
a length and a height;
the first side including one or more cavities and one or more registration keys; and
the second side including one or more cavities and one or more registration keyholes.

2. The device of claim 1 where the mold extender is made of a material that is essentially silicone.

3. The device of claim 1 where the mold extender is made of a food contact material.

4. The device of claim 1 where the mold extender has a same length as the two-part mold.

5. The device of claim 1 where the mold extender has a same width as the two-part mold.

6. The device of claim 1 where the mold extender has a same length and a same width as the two-part mold.

7. The device of claim 1 where the first side of the mold extender couples with one side of the two-part mold.

8. The device of claim 1 where the second side of the mold extender couples with one side of the two-part mold.

9. The device of claim 1 where the registration keys are coupled with one side of the two-part mold.

10. The device of claim 1 where the mold extender includes vents.

11. The device of claim 10 where the vents are located between each cavity.

12. A device to increase the output of a two-part mold, comprising:
a mold extender, comprising:
a first side and a second side; and
a length and a height;
the first side including one or more cavities and one or more registration keys; and
the second side including one or more cavities and one or more registration keyholes;
where the first side of the mold extender couples with one side of the two-part mold and the second side of the mold extender couples with one side of the two-part mold.

13. The device of claim 12 where the mold extender consists essentially of silicone.

14. The device of claim 12 where the mold extender is made of a food contact material.

15. The device of claim 12 where the mold extender has a same length as the two-part mold.

16. The device of claim 12 where the mold extender has a same width as the two-part mold.

17. The device of claim 12 where the mold extender has a same length and a same width as the two-part mold.
